(19) United States
(12) Patent Application Publication
(10) Pub. No.: US 2024/0006936 A1
(43) Pub. Date: Jan. 4, 2024

(54) STATOR CORE FOR A STATOR OF AN ELECTRIC MACHINE AND METHOD FOR PRODUCING SUCH A STATOR CORE, STATOR FOR AN ELECTRIC MACHINE, AND ELECTRIC MACHINE FOR DRIVING A VEHICLE

(71) Applicant: Valeo eAutomotive Germany GmbH, Erlangen (DE)

(72) Inventor: Carsten SIEPKER, Bad Neustadt a.d. Saale (DE)

(73) Assignee: Valeo eAutomotive Germany GmbH, Erlangen (DE)

(21) Appl. No.: 18/254,246

(22) PCT Filed: Nov. 24, 2021
(86) PCT No.: PCT/EP2021/082747

§ 371 Date: May 24, 2023

(30) Foreign Application Priority Data
Nov. 26, 2020 (DE) 10 2020 214 895.3

(51) Int. Cl. H02K 1/16; H02K 15/02

(52) U.S. Cl. CPC H02K 1/165; H02K 15/024

(57) ABSTRACT

A stator core for a stator of an electric machine includes a rotor receiving space which traverses the stator core along an axial direction; and several of slots which, in the circumferential direction, are formed successively in the stator core. The slots traverse the stator core axially from a first end side to an opposite second end side of the stator core. The slots have respectively a receiving portion in which a stator winding of the stator is able to be received, and a slot opening which is formed at a radial position between the receiving portion and the rotor receiving space and in terms of the receiving portion has relative angular positions which are mutually offset along the axial direction.

The present invention relates to a stator core for a stator of an electric machine.

Moreover, the invention relates to a method for producing a stator core, to a stator for an electric machine, and to an electric machine for driving a vehicle.

When operating an electric machine, the occurrence of cogging torques is undesirable because of a resulting torque ripple. It has already been proposed to design a stator and/or a rotor of such an electric machine in a skewed or stepped-skewed manner in order to reduce the cogging torques. In particular in the case of stators with a hairpin winding as the stator winding, which are very popular in automotive applications because of their ease of manufacture, it is conventionally very difficult to skew the stator because shaped conductors forming the stator winding are typically formed parallel along an axis of rotation of the electric machine and therefore cannot easily follow a skew of the stator.

The invention is based on the object of specifying a possibility for operating an electric machine, which is improved in comparison to the above and in particular is suitable for the simple use of a hairpin winding.

According to the invention, this object is achieved by a stator core for a stator of an electric machine, having: a rotor receiving space which traverses the stator core along an axial direction; and several of slots, which in the circumferential direction are formed successively in the stator core, travers the stator core axially from a first end side to an opposite second end side of the stator core, and have respectively a receiving portion in which a stator winding of the stator is able to be received, and a slot opening which is formed at a radial position between the receiving portion and the rotor receiving space and in terms of the receiving portion has relative angular positions which are mutually offset along the axial direction.

The stator core according to the invention for a stator of an electric machine has a rotor receiving space. The rotor receiving space traverses the stator core along an axial direction. The stator core according to the invention has several of slots. The slots are formed successively in the circumferential direction in the stator core. The slots travers the stator core axially from a first end side to an opposite second end side of the stator core. The slots have respectively a receiving portion. A stator winding of the stator is able to be received in the receiving portion. The slots have respectively a slot opening. The slot opening is formed at a radial position between the receiving portion and the rotor receiving space. The slot opening in terms of the receiving portion has relative angular positions, which are mutually offset along the axial direction.

The invention is based on the concept of emulating the effect of a skewed stator core, in which the relative angular position of the entire slot changes along the axial direction, by changing the relative angular positions of the slot opening along the axial direction. As a result, it is possible to modify a rotating field of a stator formed from the stator core according to the invention by varying the relative angular positions of the slot opening relative to the receiving portion such that cogging torques and a resulting torque ripple can advantageously be reduced.

The receiving portion of a respective slot preferably extends parallel to a longitudinal axis of the stator core. It is preferable for the receiving portion of a respective slot to lie at the same angular position in the circumferential direction across the entire axial extent of the respective slot. The receiving portion preferably has a first wall and a second wall which, when viewed from the first end side, lies opposite the first wall in the clockwise direction. In particular, the first and the second wall of the receiving portion run parallel. The slot openings preferably have a first wall and a second wall which, when viewed from the first end side, lies opposite the first wall in the clockwise direction. The first and the second wall of the slot openings preferably run parallel. Preferably, the relative angular positions of the slot opening are defined as the difference in the angular position of the first wall of the slot opening and the angular position of the first wall of the receiving portion in terms of a predetermined angular position on the stator core. Particularly in the case of receiving portions formed symmetrically in terms of a radial first axis of symmetry and a slot opening formed symmetrically along the axial direction in terms of radial second axes of symmetry, the relative angular positions of the slot opening can be defined as the difference in the angular position of the first axis of symmetry and a respective angular position of the second axes of symmetry.

In a preferred design embodiment of the stator core according to the invention, directly successive pairs of the slots are formed so as to be mutually equidistant in the circumferential direction. The receiving portion preferably has a rectangular cross-sectional area. The stator core preferably has several of teeth, which are respectively formed between a pair of directly adjacent slots. The stator core can also have a yoke, which is formed on the side of the slots radially opposite the slot openings and forms a radial delimitation of the slots, in particular of the receiving portions, and/or connects the teeth to one another in a magnetically conductive manner. The stator core according to the invention can be formed from a multiplicity of individual laminations, which are disposed in an axially layered manner. The stator core can also be referred to as a laminated stator core. In particular, the individual laminations are electrically isolated from one another.

In a preferred design embodiment, the rotor receiving space is located radially further inward than the slots. In a preferred design embodiment of the stator core according to the invention, the receiving portion of a respective slot is connected to the rotor receiving space by way of a void extending through the slot opening of the respective slot. Alternatively, the slot opening of a respective slot can be designed as a pseudo slot opening. In the pseudo slot opening, the slot opening and the receiving portion are in particular mutually separated by the stator core.

In a preferred design embodiment, it is provided in the stator core according to the invention that the relative angular positions of the slot opening are mutually offset from the first end side to an axial intermediate position between the first end side and the second end side along the same direction of rotation. In other words, a change in the relative angular positions of the slot opening along the axial direction is respectively performed along the same direction of rotation. The axial intermediate position is preferably centric between the first end side and the second end side. The direction of rotation may be clockwise or counter clockwise as viewed from the first end side.

According to a first alternative, the relative angular positions of the slot opening from the intermediate position to the second end side can be mutually set off along the same direction of rotation as the relative angular positions of the slot opening from the first end side to the axial intermediate position. In other words, the angular positions of the slot opening change along the axial direction from the first end side to the second end side with every change along the same direction of rotation. The slot opening of a respective slot preferably has a helical shape from the first end side to the second end side, in particular with a constant pitch.

According to a second alternative, the relative angular positions of the slot opening from the intermediate position to the second end side can be mutually set off along a direction of rotation, which is counter to the direction of rotation from the first end side to the axial intermediate position. In other words, the change in the relative angular positions of the slot opening takes place in the opposite direction after the intermediate position has been exceeded in the axial direction. The slot opening thus assumes an arrow shape when viewed from the rotor receiving space. Preferably, the slot opening of a respective slot has oppositely oriented helical shapes from the first end side to the intermediate position and from the intermediate position to the second end side, in particular with a constant pitch.

It is further preferred in the stator core according to the invention that the two outermost of the relative angular positions of the slot opening are spaced apart by an angular spacing which is 50 percent to 100 percent of an angular spacing of two directly adjacent slots of the stator core. With a spacing of 100 percent of the angular spacing of the directly adjacent slots, skewing by a whole slot pitch of the stator can be implemented, which allows a particularly efficient reduction of the cogging torques. This is particularly preferred in the case of the first alternative described above. A smaller angular spacing, for example 50 percent to 80 percent of the angular spacing of the directly adjacent slots, can result in a corresponding reduction in the cogging torques when a fractional slot winding or a skewed rotor is additionally used. This is particularly preferred in the case of the second alternative described above.

Particularly preferably, the relative angular positions of the slot opening are evenly distributed between the two outermost of the relative angular positions of the slot opening.

In a preferred design embodiment of the stator core according to the invention, it is provided that the first wall of the receiving portion lies between the first wall and the second wall of the slot opening at a first of the two outermost relative angular positions of the slot opening, and the second wall of the receiving portion lies between the first wall and the second wall of the slot opening at a second of the two outermost relative angular positions of the slot opening. As a result, the skew can also extend beyond the angular positions of the first wall and the second wall of the receiving portion.

Alternatively, it can be provided that at the two outermost relative angular positions of the slot opening, a first angular area spanned by the walls of the receiving portion and a second angular area spanned by the walls of the slot opening are free of any overlap and the slot opening at the two outermost relative angular positions is outside the first angular area. This is particularly preferred when the slot has a transition portion—explained in detail further below.

Alternatively, however, it is also possible for the first wall and the second wall of the slot openings to always lie between the first wall and the second wall of the receiving portion along the axial direction. In this instance, the slot opening does not exceed the angular positions of the walls of the receiving portion.

In the stator core according to the invention, it is preferred when the stator core is divided into several of partial stator cores along the axial direction and the relative angular position of the slot opening of a respective slot changes during the transition from a partial stator core to the partial stator core adjacent in the axial direction. It is also preferred when the slot openings of the slots run parallel to one another and/or parallel to the longitudinal axis of the stator core along a respective partial stator core.

In this case, each partial stator core can be formed by a multiplicity of axially layered individual laminations. In this way, the effect of a gradual skewing of the stator can be implemented. Typically, the stator core is composed of at least two, preferably at least three, particularly preferably at least four, partial stator cores and/or of at most 15, preferably at most eight, particularly preferably at most five, partial stator cores.

According to an alternative variant of design embodiment, it is provided that each partial stator core is formed from exactly one individual lamination. The effect of a continuously skewed stator can be achieved as a result.

In a preferred design embodiment, it is provided that the relative angular positions of the slot openings of several of the slots within a respective partial stator core are identical and are different in directly adjacent pairs of the partial stator cores. In particular, the relative angular positions of the slot openings of all slots within a respective partial stator core are identical and are different in directly adjacent pairs of the partial stator cores, in particular in all partial stator cores.

Alternatively or additionally, it can be provided that the relative angular positions of the slot openings of several of the slots within a respective partial stator core are different and the partial stator cores are mutually offset in the circumferential direction in such a manner that at the transition between two directly adjacent pairs of partial stator cores a change in the relative angular position of the slot openings of a respective one of the plurality of the slots is implemented. For this purpose, the angular position of the slot openings of several of slots directly successive in the circumferential direction can be formed differently in a respective partial stator core such that, when the partial stator cores are offset in the circumferential direction by one slot pitch or by multiple slot pitches, the change is respectively implemented at the transition between the directly adjacent pairs of partial stator cores. In this way, uniform geometries of the receiving portions and slot openings can in particular be used for several of partial stator cores, which advantageously reduces the number of different individual laminations to be manufactured.

In general, it is preferred in the stator core according to the invention when the slot opening has a smaller extent in the circumferential direction than the receiving portion.

In order to improve a distribution of the magnetic flux profile in the stator core, it can be provided that a respective slot has a transition portion, which is disposed radially between the receiving portion and the slot opening and connects the receiving portion and the slot opening. Preferably, at least one of two walls, preferably both walls, of the transition portion thus runs obliquely.

The object on which the invention is based is also achieved by a method for producing a stator core according to the invention, wherein a tool is used which, for shaping the slots, in particular by punching, has a first tool part for shaping the receiving portion of a respective slot and a second tool part, disposed so as to be movable relative to the first tool part, for forming the slot opening at the different relative angular positions of the latter in terms of the respective receiving portion.

The slot openings can be formed at the same time, in particular during the same punching process, conjointly with the configuration of the receiving portion. However, it is also conceivable for the receiving portion and the slot openings to be formed in sequence, in particular by separate punching processes.

The object on which the invention is based is also achieved by a stator for an electric machine, comprising a stator core according to the invention or a stator core obtained by the method according to the invention and a stator winding which is received in the receiving portion of a respective slot. The stator winding is preferably a distributed winding.

In the case of the stator according to the invention, it is also preferred that the stator winding has a fractional, non-integer ratio of the number of slots per pole and phase. This is also referred to as fractional slot winding. The number of slots per pole and phase is also referred to as the number of holes. The ratio can be 1.5 or 2.5, for example. This is particularly advantageous in combination with the fact that the two outermost of the relative angular positions are mutually spaced apart by less than a whole slot pitch, since in this instance the reduction of the cogging torques can be largely optimized.

In the stator according to the invention, it is also preferred that the stator winding is formed by shaped conductors and received in the receiving portion of a respective slot are a defined number of shaped conductors disposed so as to be stacked in the radial direction and extending in particular parallel to the longitudinal axis of the stator core. Such a stator winding can also be referred to as a hairpin winding. The shaped conductors preferably have a rectangular cross-section with optionally rounded corners. The number of shaped conductors disposed so as to be stacked in the radial direction can be, for example, at least two, preferably at least four, particularly preferably at least six and/or at most 16, preferably at most twelve, particularly preferably at most eight. The shaped conductors are preferably formed by copper rods, which in particular are not flexible. The shaped conductors are preferably dimensionally stable.

In a preferred design embodiment, pairs of the shaped conductors are electrically conductively connected to one another by connectors disposed on the end sides in such a way that at least one series connection of shaped conductors is formed per phase of the stator. Preferably, the connectors are formed on an end side of the stator core by bent portions, which are formed so as to be integral with the shaped conductors connected by them. On the other end side, the connectors preferably have a materially integral connection of two connecting elements adjoining the shaped conductors and in particular formed so as to be integral with the shaped conductors.

The object on which the invention is based is also achieved by an electric machine for driving a vehicle, comprising a stator according to the invention and an in particular permanently excited rotor rotatably mounted in the rotor receiving space. The electric machine can be designed as a synchronous machine or as an asynchronous machine. The electric machine is preferably formed to form part of a drive train of the vehicle. The vehicle may be a battery electric vehicle (BEV) or a hybrid vehicle.

The rotor of the electric machine according to the invention can be non-skewed. As a result, the cogging torques can be implemented without skewing of the rotor, which is complex in terms of production technology.

Alternatively, it can be provided that the rotor is formed so as to be skewed, in particular by half a slot pitch of the stator. This is particularly preferred in the case of the stator with a skew of half a slot pitch as an alternative to a fractional slot winding. The rotor is preferably formed by two rotor parts, which are disposed mutually offset in the circumferential direction. A transition between the rotor parts is located in particular at the axial intermediate position of the stator core. Such a rotor is preferably used conjointly with the arrow shape of the slot openings described above. Such a rotor, which has only one step for skewing, is particularly easy to manufacture in comparison to rotors with multiple steps. In particular, when the rotor is permanently excited, the permanent magnets can be introduced into the rotor from both axial end sides of the rotor and traverse the rotor up to half of its axial extent.

Further advantages and details of the present invention are derived from the exemplary embodiments described below and from the drawings. The drawings are schematic illustrations in which:

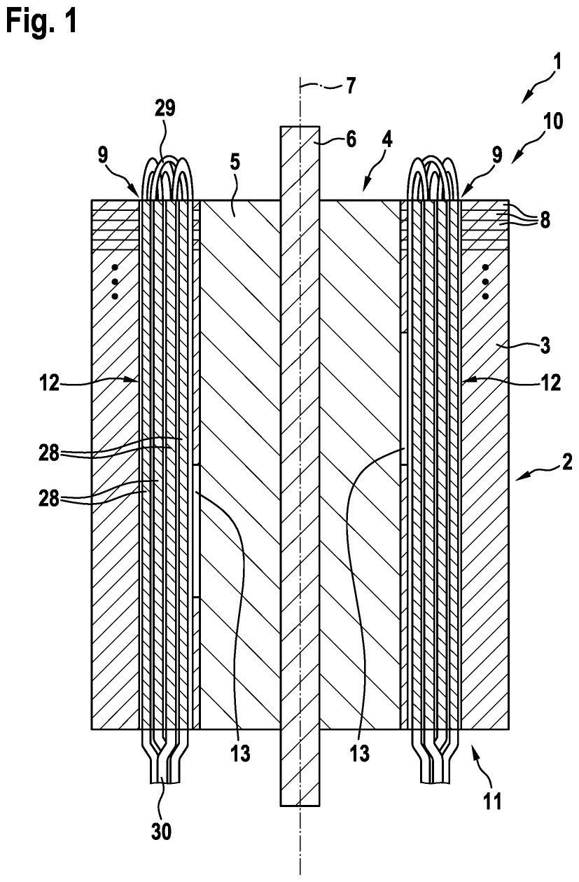

FIG. 1 shows a schematic diagram of a longitudinal section of an exemplary embodiment of the electric machine according to the invention having an exemplary embodiment of the stator according to the invention, which has an exemplary embodiment of the stator core according to the invention;

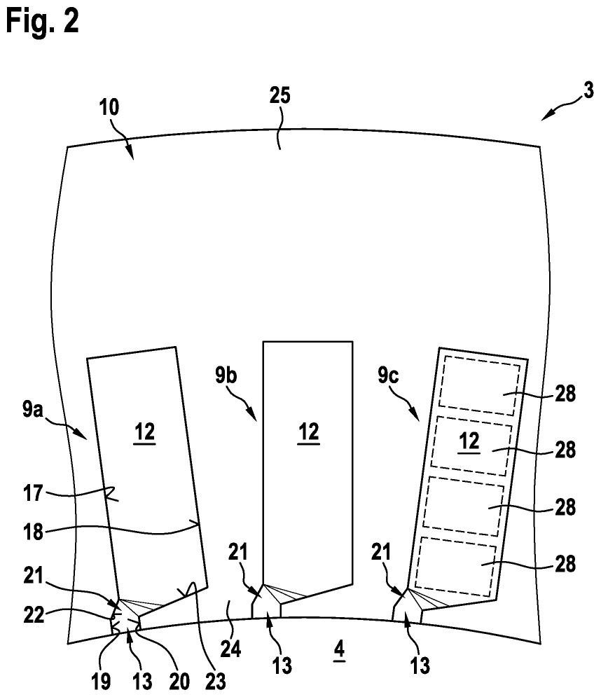

FIG. 2 shows a detailed view of an end side of the stator core according to the first exemplary embodiment;

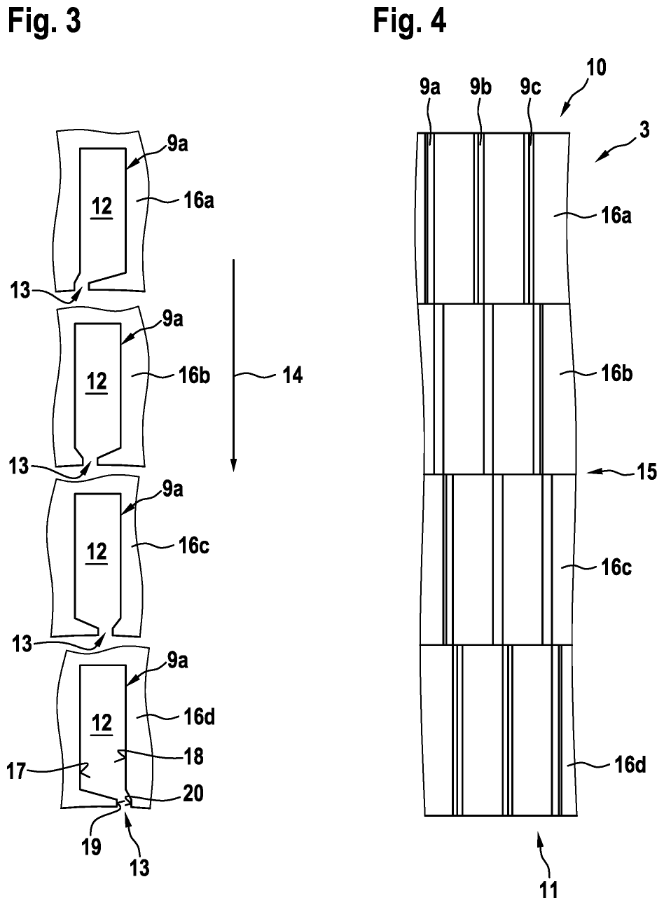

FIG. 3 shows a detailed view of a slot at different axial positions according to the first exemplary embodiment;

FIG. 4 shows a lateral detailed view of the stator core according to the first exemplary embodiment;

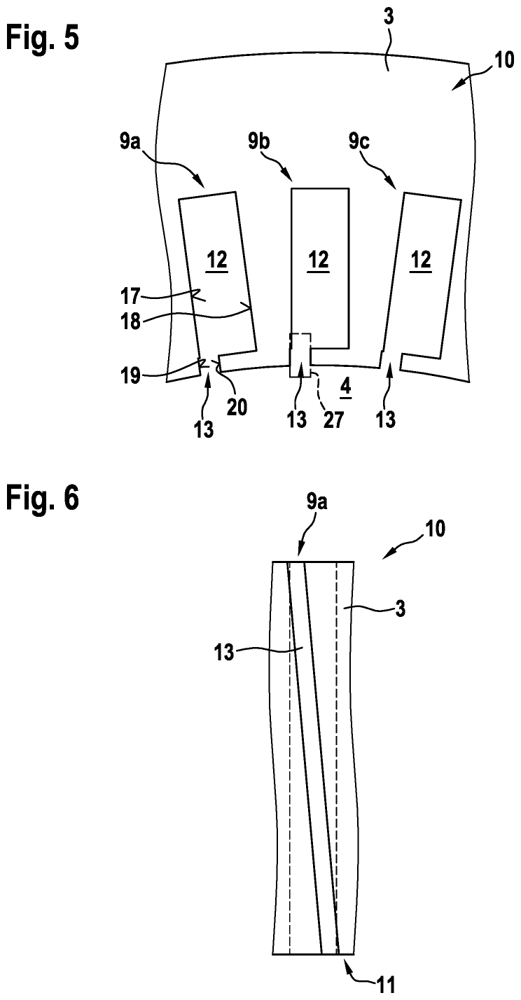

FIG. 5 shows a detailed view of an end side of a second exemplary embodiment of the stator core according to the invention;

FIG. 6 shows a schematic diagram of the axial profile of the slot opening of a slot according to the second exemplary embodiment;

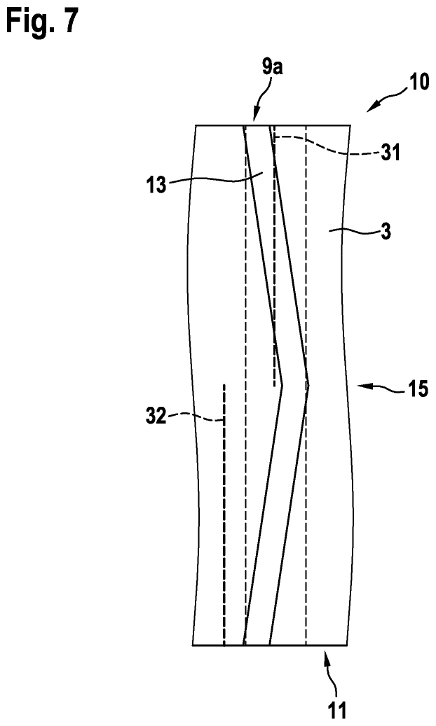

FIG. 7 shows a schematic diagram of the axial profile of the slot opening of a slot according to a third exemplary embodiment of the stator core according to the invention;

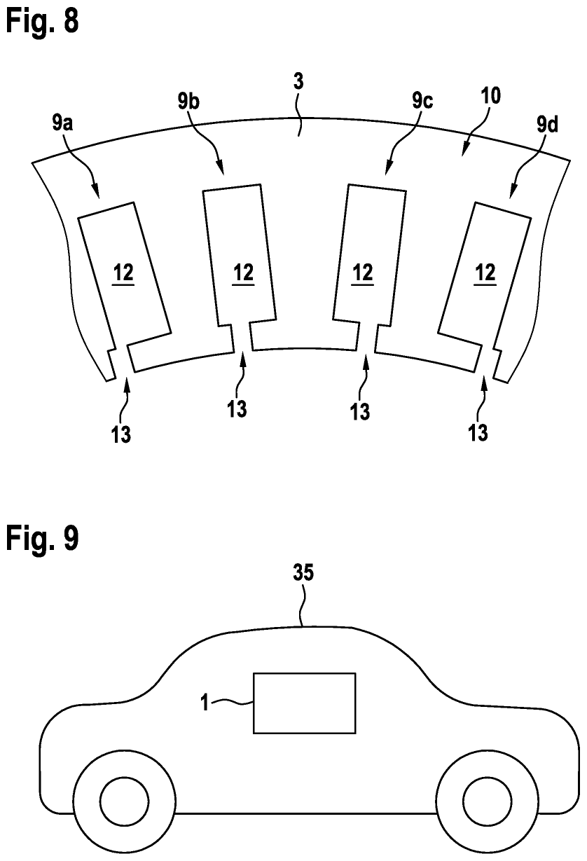

FIG. 8 shows a detailed view of an end side of a fourth exemplary embodiment of the stator core according to the invention; and

FIG. 9 shows a schematic diagram of a vehicle having an exemplary embodiment of the electric machine according to the invention.

FIG. 1 is a schematic diagram of an exemplary embodiment of an electric machine 1 having an exemplary embodiment of a stator 2, the latter having one of the exemplary embodiments of a stator core 3 described below.

The stator core 3 has a rotor receiving space 4, which traverses the stator core 3 along an axial direction. As can be seen in FIG. 1, a rotor 5 of the electric machine 1 is disposed in the rotor receiving space 4 and is co-rotationally connected to a shaft 6 of the electric machine 1. FIG. 1 furthermore shows a longitudinal axis 7 of the stator core 3, which corresponds to a rotation axis of the rotor 5.

By way of example, the stator core 3 in the present exemplary embodiment is formed from a multiplicity of axially layered individual laminations 8, which are electrically isolated from one another and are only partially shown for reasons of clarity.

The stator core 3 has several of slots 9, which in the circumferential direction are formed successively in the stator core 3. A slot pitch corresponds to the angular spacing between two directly adjacent slots 9 or the quotient of 360° and the number of slots 9 of the stator core 3. The slots 9 extend from a first end side 10 to an opposite second end side 11 of the stator core 3 in the axial direction. The slots 9 have respectively a receiving portion 12 and a slot opening 13.

FIG. 2 is a detailed view of an end side of the stator core 3 according to a first exemplary embodiment. To this end, three slots 9a-c lying directly next to one another are shown in FIG. 2 as being representative of the slots 9.

In the present exemplary embodiment, the receiving portion 12 of a respective slot 9a-c extends parallel to the longitudinal axis 7, so that the receiving portions 12 are formed to be straight along the axial direction. The slot opening 13 is formed at a radial position between the receiving portion 12 and the rotor receiving space 4.

FIG. 3 is a detailed view of the slot 9a at different axial positions according to the first exemplary embodiment. FIG. 4 is a lateral detailed view of the stator core 3 according to the first exemplary embodiment. FIG. 4 is a view from the rotor receiving space 4 onto an inner shell face of the stator core 3.

As can be derived from FIG. 3, relative angular positions in the circumferential direction of the slot opening 13 of the slot 9a are different along the axial direction, the latter in FIG. 3 being symbolized by an arrow 14 pointing from the first end side 10 to the second end side 11. As can be derived from FIG. 4, the relative angular positions of the slot opening 13 from the first end side 10 to an axial intermediate position 15, which is located centrally between the first end side 10 and the second end side 11, are mutually offset along the same direction of rotation, here by way of example in the clockwise direction. Likewise, the relative angular positions of the slot opening 13 from the intermediate position 15 to the second end side 11 are mutually offset along the same direction of rotation as the relative angular positions of the slot opening 13 from the first end side 10 to the axial intermediate position 15.

In the present exemplary embodiment, the stator core 3 is formed from several of partial stator cores 16a-d, the number of which here by way of example is four. Each partial stator core 16a-d here is formed from a multiplicity of the individual laminations 8, so that the stator core 3 can be understood as stepped. FIG. 3 shows four cross sections of the slot 9a in the different partial stator cores 16a-d. The relative angular positions of all slot openings 13 within a respective partial stator core 16a-d are identical, and different in directly adjacent pairs of the partial stator cores 16a-d, specifically mutually offset by a predetermined angular increment along the circumferential direction. Each partial stator core 16a-d is consequently formed from individual laminations 8 with an identical geometry of the slots 9a-c, the geometries of the slots 9a-c of different partial stator cores 16a-d being different.

Referring again to FIG. 2, the receiving portion 12 of a respective slot 9a-c has a first wall 17 and a second wall 18, which lies opposite the first wall in the clockwise direction. In an analogous manner, the slot opening 13 of a respective slot has a first wall 19 and a second wall 20, which lies opposite the first wall 19 in the clockwise direction. The relative angular position of the slot openings 13 in terms of the receiving portion 12 is defined here as the difference in the angular position of the first wall 19 of the slot opening 13 and the angular position of the first wall 17 of the receiving portion 12, or as the difference in the angular position of a radial first axis of symmetry A1 of the receiving portion 12 and a respective angular position of radial second axes of symmetry A2 of the slot opening 13 in terms of a predetermined angular position on the stator core 3. An outermost of the relative angular positions of the slot opening 13 is located on the first end side 10. At this outermost of the relative angular positions of the slot opening 13, the first wall 17 of the receiving portion 12 is located between the walls 19, 20 of the slot opening 13. The other outermost relative angular position lies on the second end side 11, here in the partial laminated core 16d (see FIG. 3). At the second outermost relative angular position, the second wall 18 of the receiving portion 12 is located between the walls 19, 20 of the slot opening 13. Between the two outermost of the angular positions of the slot, opening 13 there is located a spacing in the circumferential direction of approximately three quarters of a slot pitch.

Furthermore, the extent of the slot openings 13 of a respective slot 9a-c in the circumferential direction is smaller than that of the receiving portion 12. A transition portion 21, which connects the first wall 17 of the receiving portion 12 to the first wall 19 of the slot opening 13 and the second wall 18 of the receiving portion 12 to the second wall 20 of the slot opening 13, is formed between the slot opening 13 and the receiving portion 12 in a respective slot. The transition portion 21 here is located at a radial position between the receiving portion 12 and the slot opening 13, whereby walls 22, 23 of the transition portion 21 have an inclined profile.

As can be derived from FIG. 2, the stator core 3 between a respective pair of adjacent slots 9a-c has a tooth 24, the number of teeth corresponding to the number of slots 9a-c. Moreover, the stator core 3 has a yoke 25, which shapes an axial delimitation of the receiving portion 12 of a respective slot 9a-c on the side thereof opposite the slot opening 13 in the radial direction, and connects the teeth 24 to one another.

Alternatively, a larger spacing in the circumferential direction, for example of a full slot pitch, can also be located between the two outermost of the angular positions of the slot opening 13. At the two outermost relative angular positions of the slot opening 13, a first angular area spanned by the walls 17, 18 of the receiving portion 12 and a second angular area spanned by the walls 19, 20 of the slot opening 13 can be free of any overlap, so that the slot opening 13 at the two outermost angular positions lies outside the first angular area.

FIG. 5 is a detailed view of an end side of a second exemplary embodiment of a stator core 3. All explanations pertaining to the first exemplary embodiment can be applied to the second exemplary embodiment, unless otherwise described below.

Components that are the same or have the same effect are provided with identical reference signs here.

In the exemplary embodiment according to FIG. 5, the slot openings 13 at the outermost relative angular positions thereof extend only insubstantially beyond the walls 17, 18 of the receiving portion 12. According to an alternative exemplary embodiment, the walls 19, 20 of the slot openings 13 are always located between the walls 17, 18 of the receiving portion 12 across the entire axial extent of said walls 19, 20. Moreover, there is also no transition portion provided in the second exemplary embodiment, so that the receiving portion 12 at the respective slot 9a to 9c in the radial direction merges directly into the slot openings 13.

FIG. 6 is a schematic diagram of the axial profile of the slot openings 13 of the slot 9a according to the second exemplary embodiment.

In the second exemplary embodiment, each partial stator core (without a reference sign) is formed by exactly one individual lamination 8 (see FIG. 1), so that there is a continuous profile of a skew, or a continuous change in the relative angular position of the slot opening 13 in relation to the receiving portion 12, from the first end side 10 to the second end side 11 along the clockwise direction or, in an alternative embodiment, in the counter clockwise direction. As a result, the slot openings 13 have a helical shape with a constant pitch from the first end side 10 to the second end side 11.

In the second exemplary embodiment, there is a distance of approximately half a slot pitch located between the two outermost of the angular positions of the slot opening 13.

FIG. 7 is a schematic diagram of the axial profile of the opening 13 of the slot 9a according to a third exemplary embodiment of a stator core 3. The third exemplary embodiment corresponds to the second exemplary embodiment, unless otherwise described below. Components that are the same or have the same effect are provided with identical reference signs here.

In the third exemplary embodiment, the relative angular positions of the slot opening 13 from the intermediate position 15 to the second end side 11 are mutually offset along a direction of rotation opposite to the direction of rotation from the first end side 10 to the axial intermediate position 12. Here, the angular positions from the intermediate position 15 to the second end side 11 are offset in the counter clockwise direction. As a result, the slot openings 13 have a helical shape from the first end side 10 to the intermediate position 15 and an oppositely oriented helical shape from the intermediate position 15 to the second end side 11, the pitches of both helical shapes being identical. As a result, when viewed from the rotor receiving space 4, an arrow shape of the slot openings 13 is implemented.

FIG. 8 is a detailed view of an end side of a fourth exemplary embodiment of the stator core 3. The fourth exemplary embodiment corresponds to the first exemplary embodiment unless otherwise described below. Components that are the same or have the same effect are provided with identical reference signs here.

In the fourth exemplary embodiment, the relative angular positions of the slot openings 13 of several of slots 9a-d within a respective partial stator core 16a-d (see FIG. 4) are different. The partial stator cores 16a-d are mutually offset in the circumferential direction such that a change in the relative angular position of the slot openings 13 in a respective one of the plurality of slots 9a-d is implemented in the transition between two directly adjacent pairs of partial stator cores 16a-d. In the exemplary embodiment according to FIG. 8, the slots 9a-d have the same geometry in all partial stator cores 16a-d. The change in the relative angular position is achieved in that the partial stator cores 16a-d are disposed next to one another in the axial direction by way of an offset in the circumferential direction of respectively one slot pitch. As a result, the slot geometry, which in FIG. 8 is associated with the slot 9b on the first end side 10 or in the partial stator core 16a, shapes the slot 9a in the partial stator core 16b that follows in the axial direction. Accordingly, the slot geometry in the partial stator core 16c, which in FIG. 8 is associated with the slot 9c on the first end side 10, shapes the slot 9a, etc., such that a change in the relative angular positions of the slot opening 13 of a respective slot 9a-d is created along the axial direction.

According to a further exemplary embodiment, the slot geometries according to FIG. 2 and FIG. 8 can also be combined.

Within the scope of an exemplary embodiment of a method for producing a stator core 3, it is provided that a tool is used which, for shaping the slots 9, has a first tool part for shaping the receiving portion 12 of a respective slot 9 and a second tool part, disposed so as to be movable relative to the first tool part, for forming the slot openings 13 at the different relative angular positions of the latter in terms of the respective receiving portion 12. To this end, FIG. 5 schematically shows a punching area 27 of the second tool part.

Referring again to FIG. 1, the stator winding of the stator 2 is formed in the form of a hairpin winding. This means that in a respective receiving portion 12 of one of the slots 9 there is disposed a predetermined number of shaped conductors 28, in this case by way of example 4 pieces. As is schematically illustrated in FIG. 2, the shaped conductors 28 have a rectangular cross—section with rounded corners and are disposed in several of layers, here four layers by way of example, within a respective receiving portion 12. Thus due the receiving portions 12 running parallel to the longitudinal axis 7, the shaped conductors 28, which are likewise straight, can be easily received in the slots 9. A skew of the stator 2 is emulated by the variable relative angular position of the slot opening 13 of a respective slot 9. This means that the rotating field generated during operation of the electric machine 1 corresponds substantially to that of a stator in which the entire slot is formed at different angular positions along the axial direction.

As can furthermore be seen from FIG. 1, the shaped conductors 28 are electrically connected to one another on one of the end sides, here the first end side 10, by means of connectors of the first type 29 so as to form at least one series connection per phase of the stator 2. A respective connector of the first type 29 has a bent portion which from the first end side 10 protrudes outward in the axial direction—pointing away from the stator core 3—and is formed so as to be integral with the two shaped conductors 28 connected by the connector of the first type 29. On the other of the end sides, here on the second end side 11, connectors of the second type 30 are provided. A respective connector of the second type 30 is formed by two connecting portions which are formed so as to be integral with the shaped conductors 28, not connected by connectors of the first type 29, and are connected to one another in a materially integral manner by welding.

The rotor 5 of the electric machine 1, which by way of example is formed as a synchronous machine, is permanently excited. According to an exemplary embodiment of the electric machine 1, which preferably has the stator 2 according to the first exemplary embodiment, the rotor is designed without skew.

According to a further exemplary embodiment of an electric machine 1, which preferably has the stator 2 according to the second or third exemplary embodiment, the rotor 5 is of simple stepped-skewed design, wherein shown schematically by dashed lines 31, 32 in FIG. 7 is a step of the rotor 5 formed between two rotor parts. Permanent magnets, which form one pole of the rotor 5, extend along the lines 31, 32. As a result of the arrow-shaped profile of the slot openings 13, which comprises half a slot pitch of the stator 2, and the gradation of the rotor 5 shown by the lines 31, 32, which corresponds to half a slot pitch of the stator 2, a significant reduction in cogging torques can be achieved. As an alternative to the simple stepped-skewed rotor 5, the latter can be non-skewed or straight, whereby the stator 2 in this instance preferably has a fractional slot winding, i.e. a fractional, non-integer ratio of the number of slots per pole and phase, for example 1.5 or 2.5. By combining a skew of the stator 2 that is less than a whole slot pitch with the skewed rotor 5 or the fractional slot winding, an overall skew of the electric machine of a whole slot pitch can nevertheless be achieved.

FIG. 9 is a schematic diagram of a vehicle 35, which has an electric machine 1 for driving the vehicle 35. The electric machine 1 forms part of a drive train of the vehicle 35 formed as a battery electric vehicle (BEV) or as a hybrid vehicle.

1. A stator core for a stator of an electric machine, having:
a rotor receiving space which traverses the stator core along an axial direction; and
several of slots, which
in the circumferential direction are formed successively in the stator core,
traverse the stator core axially from a first end side to an opposite second end side of the stator core, and
have respectively a receiving portion in which a stator winding of the stator is able to be received, and a slot opening which is formed at a radial position between the receiving portion and the rotor receiving space and in terms of the receiving portion has relative angular positions which are mutually offset along the axial direction.

2. The stator core as claimed in claim 1, wherein
the relative angular positions of the slot opening from the first end side to an axial intermediate position between the first end side and the second end side are mutually offset along the same direction of rotation.

3. The stator core as claimed in claim 2, wherein
the relative angular positions of the slot opening from the intermediate position to the second end side are mutually offset
along the same direction of rotation as the relative angular positions from the first end side to the axial intermediate position, or
along a direction of rotation which is counter to the direction of rotation from the first end side to the axial intermediate position.

4. The stator core as claimed in claim 1, wherein
the slot opening has a first wall and a second wall which, when viewed from the first end side, is opposite the first wall in the clockwise direction, and the receiving portion has a first wall and a second wall which, when viewed from the first end side, is opposite the first wall in the clockwise direction, wherein
at a first of the two outermost relative angular positions of the slot opening, an angular position of the first wall of the receiving portion lies between angular positions of the first wall and the second wall of the slot opening, and at a second of the two outermost relative angular positions, an angular position of the second wall of the receiving portion lies between angular positions of the first wall and the second wall of the slot opening, or
at the two outermost relative angular positions of the slot opening, a first angular area spanned by the walls of the receiving portion and a second angular area spanned by the walls of the slot opening are free of any overlap and the slot opening is outside the first angular area at the two outermost angular positions, or
angular positions of the first wall and the second wall of the slot opening along the axial direction always lie between angular positions of the first wall and the second wall of the receiving portion.

5. The stator core as claimed in claim 1, wherein
the stator core is divided into several partial stator cores along the axial direction and the relative angular position of the slot opening of any respective slot changes during the transition from a partial stator core to the partial stator core adjacent in the axial direction.

6. The stator core as claimed in claim 5, wherein
the stator core is formed from a multiplicity of axially layered individual laminations, wherein
each partial stator core is formed by a plurality of the individual laminations, or
each partial stator core is formed from exactly one individual lamination.

7. The stator core as claimed in claim 5, wherein
the slot openings of the slots run parallel to one another in the axial direction along a respective partial stator core.

8. The stator core as claimed in claim 5, wherein
the relative angular positions of the slot openings of several of the slots within a respective partial stator core are identical and are different in directly adjacent pairs of the partial stator cores, and/or
the relative angular positions of the slot openings of several of the slots within a respective partial stator core are different and the partial stator cores are mutually offset in the circumferential direction in such a manner that in the transition between two directly adjacent pairs of partial stator cores a change in the relative angular position of the slot openings of a respective one of the plurality of the slots is implemented.

9. The stator core as claimed in claim 1, wherein
the slot opening has a smaller extent in the circumferential direction than the receiving portion, wherein a respective slot has a transition portion which is disposed radially between the receiving portion and the slot opening and connects the receiving portion and the slot opening.

10. A method for producing a stator core as claimed in claim 1, wherein a tool is used which, for shaping the slots, in particular by punching, has a first tool part for shaping the receiving portion of a respective slot and a second tool part, disposed so as to be movable relative to the first tool part, for forming the slot opening at the different relative angular positions of the latter in terms of the respective receiving portion.

11. A stator for an electric machine, comprising a stator core as claimed in claim 1 and a stator winding which is received in the receiving portion of a respective slot.

12. The stator as claimed in claim 11, wherein
the stator winding is formed by shaped conductors, and received in the receiving portion of any of the respective slots are a defined number of shaped conductors disposed so as to be stacked in the radial direction and extending in particular parallel to a longitudinal axis of the stator core.

13. The stator as claimed in claim 1, wherein
the stator winding has a fractional, non-integer ratio of the number of slots per pole and phase.

14. An electric machine for driving a vehicle, comprising a stator as claimed in claim 11 and an in particular permanently excited rotor rotatably mounted in the rotor receiving space.

15. The electric machine as claimed in claim 14, wherein
the rotor is formed so as not to be skewed or in particular so as to be skewed by half a slot pitch of the stator.

16. The stator core as claimed in claim 2, wherein
the slot opening has a first wall and a second wall which, when viewed from the first end side, is opposite the first wall in the clockwise direction, and the receiving portion has a first wall and a second wall which, when viewed from the first end side, is opposite the first wall in the clockwise direction, wherein
at a first of the two outermost relative angular positions of the slot opening, an angular position of the first wall of the receiving portion lies between angular positions of the first wall and the second wall of the slot opening, and at a second of the two outermost relative angular positions, an angular position of the second wall of the receiving portion lies between angular positions of the first wall and the second wall of the slot opening, or
at the two outermost relative angular positions of the slot opening, a first angular area spanned by the walls of the receiving portion and a second angular area spanned by the walls of the slot opening are free of any overlap and the slot opening is outside the first angular area at the two outermost angular positions, or
angular positions of the first wall and the second wall of the slot opening along the axial direction always lie between angular positions of the first wall and the second wall of the receiving portion.

17. The stator core as claimed in claim 2, wherein
the stator core is divided into several partial stator cores along the axial direction and the relative angular position of the slot opening of any respective slot changes during the transition from a partial stator core to the partial stator core adjacent in the axial direction.

18. The stator core as claimed in claim 6, wherein
the slot openings of the slots run parallel to one another in the axial direction along a respective partial stator core.

19. The stator core as claimed in claim 6, wherein
the relative angular positions of the slot openings of several of the slots within a respective partial stator core are identical and are different in directly adjacent pairs of the partial stator cores, and/or
the relative angular positions of the slot openings of several of the slots within a respective partial stator core are different and the partial stator cores are mutually offset in the circumferential direction in such a manner that in the transition between two directly adjacent pairs of partial stator cores a change in the relative angular position of the slot openings of a respective one of the plurality of the slots is implemented.

20. The stator core as claimed in claim 2, wherein
the slot opening has a smaller extent in the circumferential direction than the receiving portion, wherein a respective slot has a transition portion which is disposed radially between the receiving portion and the slot opening and connects the receiving portion and the slot opening.
